(19) United States
(12) Patent Application Publication
(10) Pub. No.: US 2026/0358885 A1
(43) Pub. Date: Nov. 12, 2026

(54) CORRECTION METHOD, HEAD-MOUNTED DISPLAY DEVICE, AND STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventor: WEN-HUI HUANG, Shenzhen (CN)

(21) Appl. No.: 19/660,487

(22) Filed: Apr. 28, 2026

(30) Foreign Application Priority Data
May 12, 2025 (CN) 202510604215.2

(51) Int. Cl. G06F 3/01; G06T 7/73

(52) U.S. Cl. CPC G06F 3/013; G06T 7/74; G06T 2207/30196

(57) ABSTRACT

This application provides a correction method, head-mounted display device, and a storage medium. The head-mounted display device includes at least one data acquisition unit, at least one display member, and an optical element. In the method, ocular information of a user is acquired, determines whether the user is a first-time user of the head-mounted display device. In response to determining that the user is the first-time user, the head-mounted display device projects a predetermined detection image from the at least one display member via the optical element to the left eye of the user and to the right eye of the user. A first image of the left eye and a second image of the right eye are acquired. Projection parameters of the at least one display member are corrected according to the first image and the second image. The method can improve the user experience.

### FIELD

The present application relates to the field of head-mounted device technology, and in particular, to a correction method, a head-mounted display device, and a storage medium.

### BACKGROUND

Head-mounted display (HMD) devices and other smart wearable electronics have found broad application across consumer electronics, education, medical, and related fields. By combining visual, auditory, and haptic feedback mechanisms, such devices deliver highly immersive interactive experiences to a user.

However, existing devices suffer from inherent limitations. Individual differences in a user’s cranial anatomy (e.g., interpupillary distance (IPD) and facial profiles) and assembly tolerances of the optical elements (e.g., lenses and micro-displays), frequently result in misalignment between the default image projection optical path and the user’s retinal image planes. Such misalignment commonly induces binocular disparity errors, which in turn cause visual fatigue, dizziness, and in more severe instances, symptoms of cybersickness, thereby substantially impairing overall user comfort and experience.

### BRIEF DESCRIPTION OF THE DRAWINGS

FIG. 1 shows a schematic diagram of a head-mounted display device provided in an embodiment of the present application.

FIG. 2 shows a flowchart of a correction method provided in an embodiment of the present application.

FIG. 3 shows a first flowchart of a method for correcting projection parameters of at least one display member provided in an embodiment of the present application.

FIG. 4 shows a second flowchart of a method for correcting projection parameters of the at least one display member provided in an embodiment of the present application.

FIG. 5 shows a flowchart of a method for determining whether a user is a first-time user of the head-mounted display device provided in an embodiment of the present application.

FIG. 6 shows a flowchart of a method for projecting a predetermined detection image to the left eye of the user and to the right eye of the user provided in an embodiment of the present application.

FIG. 7 shows a schematic structural diagram of a correction device provided in an embodiment of the present disclosure.

### DETAILED DESCRIPTION

The accompanying drawings combined with the detailed description illustrate the embodiments of the present application hereinafter. It is noted that embodiments of the present disclosure and features of the embodiments can be combined, when there is no conflict.

Various details are described in the following descriptions for a better understanding of the present application, however, the present application may also be implemented in other ways other than those described herein. The scope of the present application is not to be limited by the specific embodiments disclosed below. Unless defined otherwise, all technical and scientific terms used herein have the same meaning as commonly understood by one of ordinary skill in the art to which the present application belongs. The terms used herein in the present application are only for the purpose of describing specific embodiments and are not intended to limit the present disclosure.

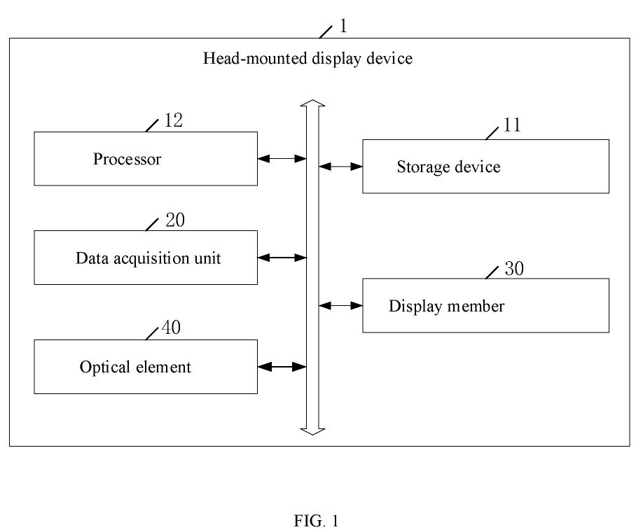

FIG. 1 is a schematic diagram of a head-mounted display device provided in an embodiment of the present application. As shown in FIG. 1, a head-mounted display device 1 includes at least one data acquisition unit 20, at least one display member 30, and an optical element 40. For example, the head-mounted display device 1 may include, but is not limited to, an Augmented Reality Glasses, the data acquisition unit 20 may include, but is not limited to, a camera, and the display member 30 may include, but is not limited to, a display screen.

In some embodiments, the head-mounted display device 1 is a device capable of automatically performing numerical calculations and/or information processing according to pre-set or stored instructions. Its hardware includes, but is not limited to, a microprocessor, an Application Specific Integrated Circuit (ASIC), a Field-Programmable Gate Array (FPGA), a Digital Signal Processor (DSP), an embedded device, and the like.

In some embodiments, the head-mounted display device 1 acquires ocular information of a user by using the at least one data acquisition unit 20, and determines whether the user is a first-time user of the head-mounted display device 1 according to the ocular information of the user and user information. The user information may be stored in the head-mounted display device 1. In other embodiments, the head-mounted display device 1 is wireless connectible, and the user information may be retrieved from a remote storage or a local storage. In response that the user is the first-time user of the head-mounted display device 1, the head-mounted display device 1 projects a predetermined detection image from the at least one display member 30 via the optical element 40 to the left eye of the user and to the right eye of the user. Furthermore, the head-mounted display device 1 acquires a first image of the left eye and a second image of the right eye by the at least one data acquisition unit 20 according to the same imaging parameters, and corrects projection parameters of the at least one display member according to the first image and the second image.

In some embodiments, the head-mounted display device 1 may be communicatively connected to a desktop computer, a notebook computer, a palmtop computer, or a cloud server.

In some embodiments, the head-mounted display device 1 can interact with the user via a keyboard, a mouse, a remote controller, a touchpad, or a voice-control device.

In some embodiments, the head-mounted display device 1 may further include a network device and/or a client device. The network device includes, but is not limited to, a single network server, a server group consisting of multiple network servers, or a cloud server composed of a large number of hosts or network servers based on Cloud Computing.

In some embodiments, the network in which the head-mounted display device 1 is located includes, but is not limited to, the Internet, a wide area network, a metropolitan area network, a local area network, a Virtual Private Network (VPN), and the like.

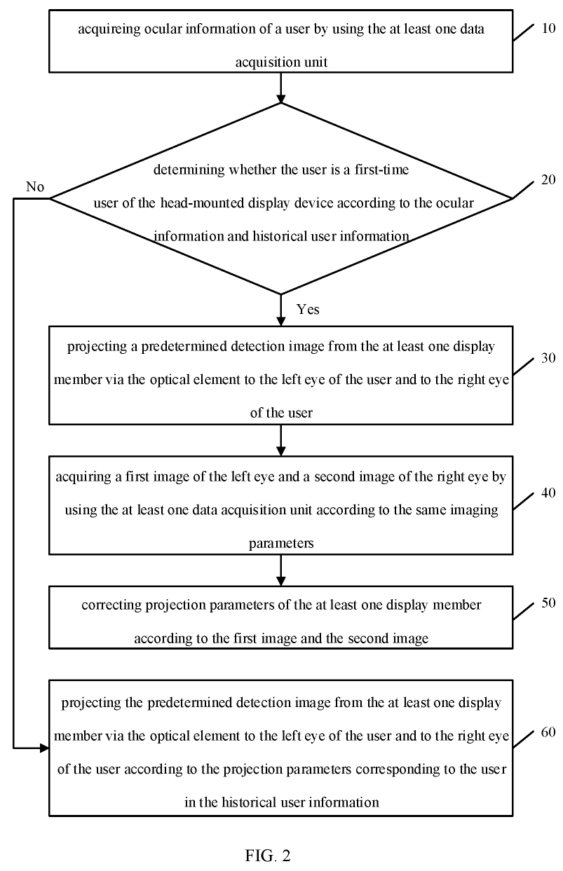

FIG. 2 is a flowchart of a correction method provided in an embodiment of the present application. As shown in FIG. 2, the correction method according to the embodiment of the present application is applied to the head-mounted display device 1, such as the head-mounted display device 1 in FIG. 1. The correction method can improve the user experience. According to different requirements, the order of following blocks can be changed, and some blocks can be omitted.

In block 10, the head-mounted display device acquires ocular information of a user by the at least one data acquisition unit.

In some embodiments, the head-mounted display device acquires the ocular information of the user. This provides basic data for subsequent user identification and projection calibration.

In some embodiments, the ocular information includes, but is not limited to, pupil features and interpupillary distance. The pupil features includes, but is not limited to, pupil size, shape, position, and iris texture.

In block 20, the head-mounted display device determines whether the user is a first-time user of the head-mounted display device according to the ocular information of the user and user information.

In some embodiments, the head-mounted display device acquires ocular information of the user, matches the ocular information with the user information. Based on a matching result, it is determined whether the user is a first-time user of the head-mounted display device. Specifically, in response to determining that no data matching the ocular information exists in the user information, the user is determined to be a first-time user of the head-mounted display device, in response to determining that data matching the ocular information exists in the user information, the user is determined not to be a first-time user of the head-mounted display device.

In block 30, the head-mounted display device determines that the user is the first-time user of the head-mounted display device and projects a predetermined detection image from the at least one display member via the optical element to the left eye of the user and to the right eye of the user.

In some embodiments, in response to determining that the user is the first-time user of the head-mounted display device, the head-mounted display device projects the predetermined detection image from the at least one display member via the optical element to the left eye of the user and to the right eye of the user, so as to provide basic data for the at least one data acquisition unit to subsequently acquire image information of both eyes of the user.

In some embodiments, the predetermined detection image may include, but is not limited to, a digital image, a dot matrix image, and a color image. In one embodiment, the predetermined detection image is an image having five dot features, wherein one dot feature is a center dot feature located at the center of the predetermined detection image, and the other four dot features are edge dot features. The four edge dot features are arranged around the center dot feature and form a rectangle. After the head-mounted display device projects the predetermined detection image having five dot features from the at least one display member via the optical element to the left eye of the user and to the right eye of the user, and prompts the user to gaze at the center dot feature, thereby causing the user's line of sight to align with the center of the predetermined detection image. This reduces errors caused by the user's offset, keeps the user's line of sight within the imaging range of the at least one data acquisition unit, and facilitates subsequent accurate detection and correction of the projection position and projection angle of the at least one display member. It also clarifies the gaze prompt and correction operation process, thereby improving user experience. The head-mounted display device 1 may prompt the user to gaze at the center dot feature through voice, screen display, vibration, or the like.

In some embodiments, the at least one display member comprises a first display member. The head-mounted display device projects the predetermined detection image from the first display member via the optical element to the left eye of the user and separately to the right eye of the user. Providing a single display member reduces the cost of the head-mounted display device and improves space utilization. In one embodiment, the optical element includes, but is not limited to, a beam splitter and a polarizer.

In some embodiments, the at least one display member comprises a first display member and a second display member. The head-mounted display device projects the predetermined detection image from the first display member via the optical element to the left eye of the user, and projects the predetermined detection image from to the second display member via the optical element to the right eye of the user, thereby reducing visual deviation between the left eye and the right eye and improving subsequent calibration accuracy.

In other embodiments, the head-mounted display device may acquire a detection image and perform a preprocessing operation on the detection image to obtain the predetermined detection image. Specifically, the preprocessing operation includes, but is not limited to, image enhancement, noise removal, and edge sharpening performed on the detection image. In one embodiment, the preprocessing operation improves the clarity and contrast of the predetermined detection image, effectively enhances the image quality of the predetermined detection image, and ensures that the head-mounted display device projects a high-quality predetermined detection image to both eyes of the user, thereby guaranteeing the accuracy of subsequent image information acquisition.

In block 40, the head-mounted display device acquires a first image of the left eye and a second image of the right eye by the at least one data acquisition unit according to same imaging parameters.

In some embodiments, the first image includes the predetermined detection image projected to the left eye, and the second image includes the predetermined detection image projected to the right eye. Specifically, the head-mounted display device acquires a first image of the left eye and a second image of the right eye by using the at least one data acquisition unit according to the same imaging parameters, thereby facilitating subsequent correction of projection parameters of the at least one display member based on the first image and the second image.

In some embodiments, the imaging parameters include, but are not limited to, an imaging field of view, an imaging range, and an imaging frame rate. The data acquisition unit performs imaging by using the same imaging parameters to ensure that the acquired first image and second image have the same field of view, size, and color, thereby facilitating subsequent correction of the projection parameters of the at least one display member based on the first image and the second image.

In some embodiments, the at least one data acquisition unit includes a first data acquisition unit. The head-mounted display device acquires a first image of the left eye and a second image of the right eye by using the first data acquisition unit according to the same imaging parameters.

In other embodiments, the at least one data acquisition unit includes a first data acquisition unit and a second data acquisition unit. The first data acquisition unit acquires the first image of the left eye, and the second data acquisition unit acquires the second image of the right eye, respectively, using the same imaging parameters, thereby better simulating the user's binocular vision, ensuring accurate acquisition of the first image and the second image, and facilitating precise correction of projection deviations of the at least one display member. In addition, acquiring images using the same imaging parameters ensures a consistent viewpoint and field of view, thereby preventing variations caused by movement of the user's head. This ensures that the image area and field of view of the first image and the second image are identical, thereby facilitating accurate comparison and enabling precise calibration of the projection parameters of the at least one display member.

In block 50, the head-mounted display device corrects projection parameters of the at least one display member according to the first image and the second image.

In some embodiments, the head-mounted display device compares the first image with the second image to determine projection parameter deviations and correct the projection parameters of the at least one display member, thereby ensuring image fusion of the left eye and the right eye, reducing visual fatigue and discomfort of the user, and improving user experience.

In some embodiments, the projection parameters include, but are not limited to, a projection angle, a projection position.

In some embodiments, the head-mounted display device stores the corrected projection parameters and the ocular information, facilitating rapid matching and adjustment during subsequent use, thereby reducing waiting time and operational complexity for the user upon re-entry.

In block 60, the head-mounted display device determines that the user is not the first-time user of the head-mounted display device, and projects the predetermined detection image from the at least one display member via the optical element to the left eye of the user and to the right eye of the user according to the projection parameters corresponding to the user in the user information.

In some embodiments, according to the ocular information of the user and the user information, the user is precisely identified to determine whether the user is a first-time user of the head-mounted display device. In response to determining that the user is a first-time user of the head-mounted display device, the predetermined detection image from the at least one display member is further projected to the left eye and the right eye of the user via the optical element. The projection parameters of the at least one display member are then corrected according to the first image of the left eye and the second image of the right eye, thereby ensuring that the user can achieve binocular fusion when using the head-mounted display device. This prevents the user from experiencing visual fatigue, dizziness, or other discomforts, and improves the user experience.

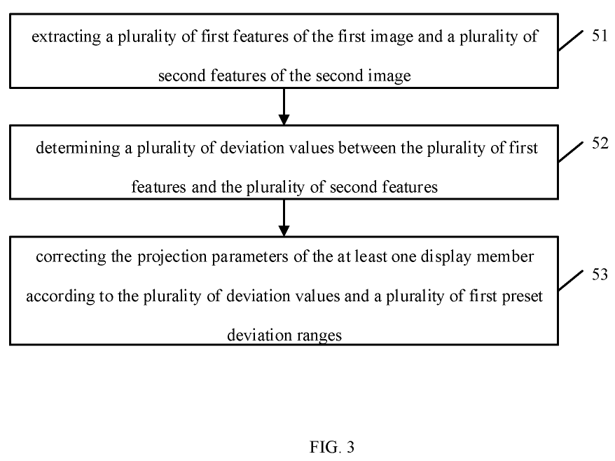

FIG. 3 is a first flowchart of a method for correcting projection parameters of at least one display member provided in an embodiment of the present application.

In block 51, the head-mounted display device extracts a plurality of first features of the first image and a plurality of second features of the second image.

In some embodiments, the first data acquisition unit and the second data acquisition unit acquire the first image of the left eye and the second image of the right eye, respectively, using the same imaging parameters, such that the first image and the second image have the same image area and image angle of view. The difference between the first image and the second image lies in the projection position and projection angle of the predetermined detection image projected to the left eye of the user and to the right eye of the user. Extracting the plurality of first features of the first image and the plurality of second features of the second image provides basic data for subsequent correction of the projection position and projection angle of the at least one display member.

In some embodiments, since the predetermined detection image has five dot features and the first image and the second image include the predetermined detection image, the five dot features extracted from the first image are determined as the plurality of first features, and the five dot features extracted from the second image are determined as the plurality of second features.

In block 52, the head-mounted display device determines a plurality of deviation values between the plurality of first features and the plurality of second features.

In some embodiments, the head-mounted display device performs a comparison between the plurality of first features and the plurality of second feature, thereby determining an angular deviation and a positional deviation between the plurality of first features and the plurality of second features.

In some embodiments, the head-mounted display device establishes a common two-dimensional coordinate system for the first image and the second image, thereby obtaining positions and angles of the plurality of first features and the plurality of second features within the coordinate system. Specifically, each of the plurality of first features is defined as a first reference point. For each first reference point, an angular deviation and a positional deviation relative to its corresponding second feature among the plurality of second features are computed, and the computed plurality of angular deviations and the plurality of positional deviations are determined as a plurality of deviation values between the plurality of first features and the plurality of second features. Alternatively, each of the plurality of second features is defined as a second reference point. For each second reference point, an angular deviation and a positional deviation relative to its corresponding first feature among the plurality of first features are computed, and the computed plurality of angular deviations and the plurality of positional deviations are determined as a plurality of deviation values between the plurality of first features and the plurality of second features.

In block 53, the head-mounted display device corrects the projection parameters of the at least one display member according to the plurality of deviation values and a plurality of first preset deviation ranges.

In some embodiments, the projection parameters include, but are not limited to, a projection position and a projection angle. The head-mounted display device pre-stores the plurality of first preset deviation ranges and compares each of the plurality of deviation values with a corresponding first preset deviation range among the plurality of first preset deviation ranges. In response to determining that each of the plurality of deviation values is within its corresponding first preset deviation range, the head-mounted display device determines that the projection position and projection angle of the display member are appropriate, and determines that no correction of the projection position and projection angle is needed. In response to determining that any one of the plurality of deviation values is not within its corresponding first preset deviation range, the head-mounted display device determines that correction of the projection position and projection angle is needed. Specifically, the head-mounted display device calculates a difference between each of the plurality of deviation values and its corresponding first preset deviation range, determines a projection position offset and a projection angle offset based on the difference, and corrects the projection position and projection angle of each of the at least one display member according to the projection position offset and the projection angle offset, thereby ensuring binocular fusion for the user.

In some embodiments, for each of the at least one display member, the head-mounted display device may drive the display member to move via a mechanical adjustment device connected to the display member to precisely adjust the projection position and projection angle of the display member. In one embodiment, the mechanical adjustment device may include, but is not limited to, a micro-electromechanical system (MEMS) actuator, a piezoelectric ceramic actuator, or the like. In some other embodiments, the head-mounted display device may also precisely adjust the projection position and projection angle of the display member by adjusting optical parameters, image output parameters, or the like of the display member.

By extracting a plurality of first features from the first image and a plurality of second features from the second image, comparing the plurality of first features with the plurality of second features, and then, based on a plurality of deviation values between the plurality of first features and the plurality of second features, correcting the display member, binocular fusion of the user is ensured, and the user experience is improved.

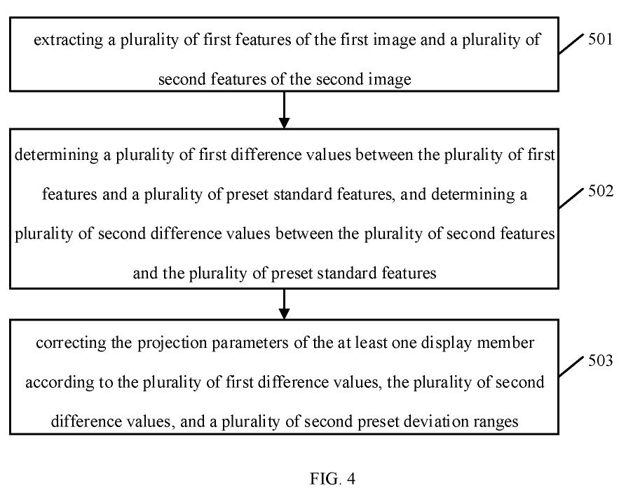

FIG. 4 is a second flowchart of a method for correcting projection parameters of the at least one display member provided in an embodiment of the present application.

In block 501, the head-mounted display device extracts a plurality of first features of the first image and a plurality of second features of the second image.

In some embodiments, as described in the above block 51, the head-mounted display device extracts the plurality of first features of the first image and the plurality of second features of the second image, and thereby provides basic data for subsequent correction of the projection position and projection angle of the at least one display member.

In block 502, the head-mounted display device determines a plurality of first difference values between the plurality of first features and a plurality of preset standard features, and determines a plurality of second difference values between the plurality of second features and the plurality of preset standard features.

In some embodiments, the head-mounted display device pre-stores a plurality of preset standard features. Each of the plurality of preset standard features may be a feature that is located at a predetermined position in the first image taken at a preset angle. Alternatively, each of the plurality of preset standard features may be a feature that is located at a predetermined position in the second image taken at a preset angle.

In some embodiments, the head-mounted display device compares each of the plurality of first features and each of the plurality of second features with a corresponding preset standard feature in the plurality of preset standard features, and thereby determines a first difference value between each of the plurality of first features and the corresponding preset standard feature and a second difference value between each of the plurality of second features and the corresponding preset standard feature. In one embodiment, the first difference value and the second difference value each include an angle deviation and a position deviation.

In some embodiments, the same two-dimensional coordinate system may be established in the first image and the second image to obtain the positions and angles of each of the plurality of first features and each of the plurality of second features in the two-dimensional coordinate system. The head-mounted display device takes the plurality of preset standard features as a reference to obtain a deviation between each of the plurality of first features and a corresponding preset standard feature in the plurality of preset standard features, and a deviation between each of the plurality of second features and a corresponding preset standard feature in the plurality of preset standard features, and thereby determining the plurality of first difference values and the plurality of second difference values.

In block 503, the head-mounted display device corrects the projection parameters of the at least one display member according to the plurality of first difference values, the plurality of second difference values, and a plurality of second preset deviation ranges.

In some embodiments, the head-mounted display device pre-stores a plurality of second preset deviation ranges. Each of the plurality of second preset deviation ranges corresponds to a first difference value or a second difference value.

In some embodiments, the head-mounted display device compares each of the plurality of first difference values with a corresponding second preset deviation range among the plurality of second preset deviation ranges. In response to determining that each of the plurality of first difference values is within its corresponding second preset deviation range and each of the plurality of second difference values is within its corresponding second preset deviation range, the head-mounted display device determines that the projection position and projection angle of the display member are appropriate, and determines that no correction of the projection position and projection angle is needed. In response to determining that any one of the plurality of first difference values is not within its corresponding second preset deviation range or any one of the plurality of second difference values is not within its corresponding second preset deviation range, the head-mounted display device determines that correction of the projection position and projection angle is needed.

In some embodiments, the head-mounted display device calculates differences between each of the plurality of first difference values and its corresponding second preset deviation range and differences between each of the plurality of second difference values and its corresponding second preset deviation range , determines a projection position offset and a projection angle offset based on the differences, and corrects the projection position and projection angle of each of the at least one display member according to the projection position offset and the projection angle offset, thereby ensuring binocular fusion for the user.

In some embodiments, it can be understood that the correction method of the at least one display member in block 53 is the same as that in block 503. The head-mounted display device may drive the display member to move via a mechanical adjustment device connected to the display member to precisely adjust the projection position and projection angle of the display member. In some other embodiments, the head-mounted display device may also precisely adjust the projection position and projection angle of the display member by adjusting optical parameters, image output parameters, or the like of the display member.

In some embodiments, the head-mounted display device ensures binocular fusion of the user and improves the user experience by extracting a plurality of first features from the first image and a plurality of second features from the second image, comparing the plurality of first features with the plurality of second preset deviation ranges and the plurality of second features with the plurality of second preset deviation ranges, and then, based on the plurality of first difference values, the plurality of second difference values, and the plurality of second preset deviation ranges, correcting the at least one display member.

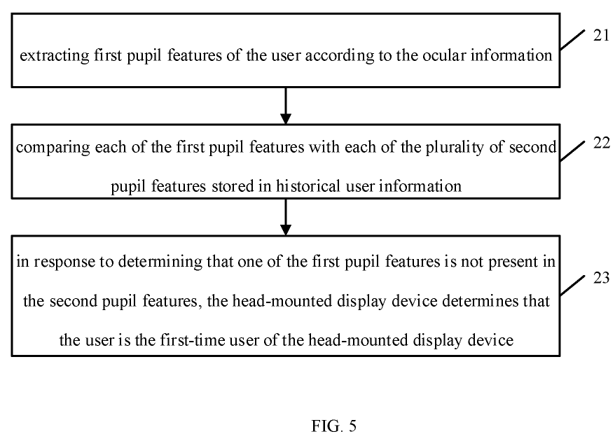

FIG. 5 is a flowchart of a method for determining whether a user is a first-time user of the head-mounted display device provided in an embodiment of the present application.

In block 21, the head-mounted display device extracts first pupil features of the user according to the ocular information.

In some embodiments, the head-mounted display device extracts key pupil features from the ocular information for subsequent user identification, thereby improving accuracy and reliability of the user identification. In one embodiment, the first pupil features include, but are not limited to, pupil size, pupil shape, pupil position, and iris texture.

In block 22, the head-mounted display device compares each of the first pupil features with each of the plurality of second pupil features stored in the user information.

In some embodiments, the head-mounted display device compares each of the first pupil features of the user with each of the plurality of second pupil features stored in the user information, thereby obtaining a plurality of similarities. In response that each of the plurality of similarities is greater than a preset similarity threshold, it is determined that each of the first pupil features is present in the plurality of second pupil features. In response that any one of the plurality of similarities is less than the preset similarity threshold, it is determined that the first pupil features is absent in the plurality of second pupil features. In one embodiment, the preset similarity threshold may be 60%, 70%, 80%, 90%, 100%, and the like.

In block 23, in response to one of the first pupil features is determined absent in the plurality of second pupil features, the head-mounted display device determines the user is the first-time user of the head-mounted display device.

In some embodiments, in response that any one of the plurality of similarities is less than the preset similarity threshold, the head-mounted display device determines that the user is the first-time user of the head-mounted display device.

In some embodiments, by performing the above block 21 to block 23, the first pupil features of the user are extracted from the ocular information and compared with each of the plurality of second pupil features stored in the user information. Accurate determination of whether the user is a first-time user is achieved according to the plurality of similarities, which facilitates determining whether to perform block 30.

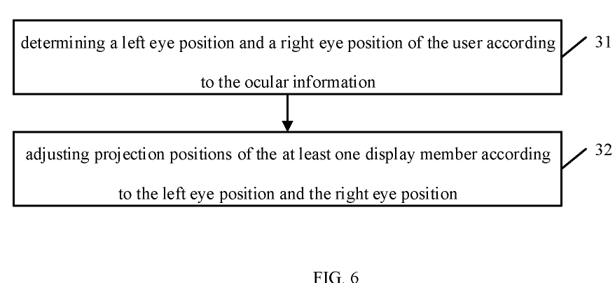

FIG. 6 is a flowchart of a method for projecting a predetermined detection image to the left eye of the user and to the right eye of the user provided in an embodiment of the present application.

In block 31, the head-mounted display device determines a left eye position and a right eye position of the user according to the ocular information.

In some embodiments, the left eye position and the right eye position of the user are determined by analyzing the ocular information, providing basic data for subsequent projection operations of the head-mounted display device.

In block 32, the head-mounted display device adjusts projection positions of the at least one display member according to the left eye position and the right eye position.

In some embodiments, in response to the at least one display member including a first display member, the head-mounted display device adjusts a projection position of the first display member according to the left eye position and the right eye position and projects the predetermined detection image from the first display member via the optical element to the left eye of the user and separately to the right eye of the user. Specifically, the head-mounted display device calculates a first difference between the left eye position and a preset position, and a second difference between the right eye position and the preset position. The projection position of the first display member is then adjusted according to the first difference and the second difference. In one embodiment, the preset position may be set based on historical data, which is not limited in the present embodiment.

In some embodiments, the projection positions can include a first projection position and a second projection position. In response to the at least one display member including a first display member and a second display member, the head-mounted display device determines the left eye position and the right eye position of the user according to the ocular information. Further, the head-mounted display device adjusts a first projection position of the first display member according to the left eye position and a second projection position of the second display member according to the right eye position, and projects the predetermined detection image from the first display member via the optical element to the left eye of the user, and from the second display member via the optical element to the right eye of the user. Specifically, the head-mounted display device calculates a third difference between the left eye position and a preset left eye position, and a fourth difference between the right eye position and a preset right eye position. The first projection position of the first display member is adjusted according to the third difference, and the second projection position of the second display member is adjusted according to the fourth difference. In one embodiment, both the preset left eye position and the preset right eye position may be set based on historical data, which is not limited in the present embodiment.

In other embodiments, the projection positions can include a third projection position and a fourth projection position. In response to the at least one display member including a first display member and a second display member, the head-mounted display device determines the left eye position and the right eye position of the user according to the ocular information. Further, the head-mounted display device adjusts the third projection position of the first display member according to the left eye position and the right eye position and the fourth projection position of the second display member according to the left eye position and the right eye position, and projects the predetermined detection image from the first display member via the optical element to the left eye of the user, and from the second display member via the optical element to the right eye of the user. Specifically, the head-mounted display device calculates a fifth difference between the left eye position and the preset left eye position, and a sixth difference between the right eye position and the preset right eye position. The third projection position of the first display member is adjusted according to the fifth difference and the sixth difference, and the fourth projection position of the second display member is adjusted according to the fifth difference and the sixth difference. In one embodiment, both the preset left eye position and the preset right eye position may be set based on historical data, which is not limited in the present embodiment.

In this way, by performing the above blocks 31 and 32, the left eye position and the right eye position of the user are determined according to the ocular information, and the projection position of the at least one display member is initially adjusted based on the left eye position and the right eye position. This ensures that the at least one display member can project the detection image to both eyes of the user, simplifies subsequent correction steps, and improves overall calibration efficiency.

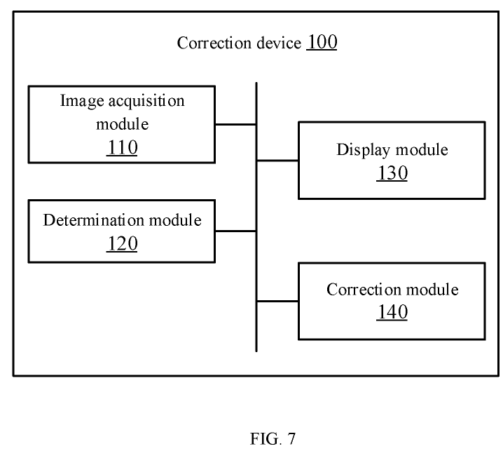

FIG. 7 is a schematic structural diagram of a correction device provided in an embodiment of the present disclosure.

In some embodiments, based on the same concept as the above correction method, the present application further provides a correction device 100, which can be used to execute the above correction method. For convenience of description, only the parts related to the embodiments of the present application are shown in the schematic diagram of the composition of the correction device 100. Those skilled in the art can understand that the illustrated structure does not constitute a limitation on the correction device 100, and may include more or fewer components than shown, or combine some components, or arrange components differently.

Specifically, the correction device 100 provided by the embodiment of the present application includes an image acquisition module 110, a determination module 120, a display module 130, and a correction module 140.

In some embodiments, the image acquisition module 110 acquires ocular information of a user by using the at least one data acquisition unit. The determination module 120 determines whether the user is a first-time user of the head-mounted display device according to the ocular information of the user and the user information. The display module 130 determines that the user is the first-time user of the head-mounted display device, and projects a predetermined detection image from the at least one display member via the optical element to the left eye of the user and to the right eye of the user. The image acquisition module 110 acquires a first image of the left eye and a second image of the right eye by using the at least one data acquisition unit according to the same imaging parameters. The correction module 140 corrects projection parameters of the at least one display member according to the first image and the second image.

In some embodiments, the correction device 100 uses the ocular information of the user and the user information to precisely identify the user and determine whether the user is a first-time user of the head-mounted display device. In response to determining that the user is a first-time user, the correction device 100 projects a predetermined detection image from the at least one display member via the optical element to the left eye and the right eye of the user. The correction device 100 then corrects the projection parameters of the at least one display member according to the first image of the left eye and the second image of the right eye. This configuration ensures that the user can achieve binocular fusion when using the head-mounted display device, thereby preventing the user from experiencing visual fatigue, dizziness, or other discomforts and improving the user experience.

As shown in FIG. 1, in some embodiments of the present application, the head-mounted display device 1 includes, but is not limited to, a storage device 11, a processor 12, and a computer program stored in the storage device 11 and executable on the processor 12, such as a calibration program. When the computer program is executed by the processor 12, the correction method according to the above embodiments is implemented.

FIG. 1 only shows the head-mounted display device 1 having the storage device 11 and the processor 12. Those skilled in the art can understand that the structure shown in FIG. 1 does not constitute a limitation on the head-mounted display device 1, and may include fewer or more components than shown, or combine some components, or arrange components differently.

The storage device 11 in the head-mounted display device 1 stores a plurality of computer-readable instructions for implementing a correction method. The processor 12 can execute a plurality of instructions to acquire ocular information of a user by using the at least one data acquisition unit, determine whether the user is a first-time user of the head-mounted display device according to the ocular information and the user information, determine that the user is the first-time user of the head-mounted display device, project a predetermined detection image from the at least one display member via the optical element to the left eye of the user and to the right eye of the user, acquire a first image of the left eye and a second image of the right eye by using the at least one data acquisition unit according to the same imaging parameters, and correct projection parameters of the at least one display member according to the first image and the second image.

Specifically, for the specific implementation method of the above instructions by the processor 12, reference may be made to the description of the relevant steps in the embodiment corresponding to FIG. 2, which will not be repeated here.

Those skilled in the art can understand that the schematic diagram is merely an example of the head-mounted display device 1 and does not constitute a limitation on the head-mounted display device 1. The head-mounted display device 1 may have a bus structure or a star structure, and may further include more or fewer other hardware or software, or different component arrangements, for example, the head-mounted display device 1 may further include input/output devices, network access devices, and the like.

It should be noted that the head-mounted display device 1 is merely an example. Other existing or future electronic products that can be adapted to the present application should also be included in the protection scope of the present application and are incorporated herein by reference.

The storage device 11 includes at least one type of computer-readable storage medium, which may be non-volatile or volatile. The computer-readable storage medium includes flash memory, a removable hard disk, a multimedia card, a card-type memory (such as SD memory, DX memory, etc.), magnetic memory, a magnetic disk, an optical disk, and the like. In some embodiments, the storage device 11 may be an internal storage unit of the head-mounted display device 1, such as a removable hard disk of the head-mounted display device 1. In other embodiments, the storage device 11 may also be an external storage device of the head-mounted display device 1, such as a plug-in mobile hard disk, a Smart Media Card (SMC), a Secure Digital (SD) card, a Flash Card, and the like provided on the head-mounted display device 1. The storage device 11 is not only used to store application software installed on the head-mounted display device 1 and various types of data, such as codes of a calibration program, but also used to temporarily store data that has been output or is to be output.

In some embodiments, the processor 12 may be composed of integrated circuits, for example, a single packaged integrated circuit or multiple integrated circuits with the same or different functions, including one or more Central Processing Units (CPU), microprocessors, digital processing chips, graphics processors, and various control chips. The processor 12 is the control core (Control Unit) of the head-mounted display device 1. It connects various components of the entire head-mounted display device 1 using various interfaces and lines, and executes various functions and processes data of the head-mounted display device 1 by running or executing programs or modules stored in the storage device 11 (for example, executing a calibration program, etc.) and calling data stored in the storage device 11.

The processor 12 executes the operating system of the head-mounted display device 1 and various installed applications. The processor 12 executes applications to implement the steps in the above embodiments of the correction method.

For example, the computer program may be divided into one or more modules/units. One or more modules/units are stored in the storage device 11 and executed by the processor 12 to complete the present application. One or more modules/units may be a series of computer-readable instruction segments capable of completing specific functions. The instruction segments are used to describe the execution process of the computer program in the head-mounted display device 1.

The integrated unit implemented in the form of a software functional module may be stored in a computer-readable storage medium. The above software functional module is stored in a storage medium and includes several instructions for causing a computer device (which may be a personal computer, a computer device, or a network device, etc.) or the processor 12 to execute part of the correction method according to various embodiments of the present application.

If the integrated module/unit of the head-mounted display device 1 is implemented in the form of a software functional unit and sold or used as an independent product, it may be stored in a computer-readable storage medium. Based on such understanding, all or part of the processes in the methods of the above embodiments of the present application may also be completed by instructing relevant hardware through a computer program. The computer program may be stored in a computer-readable storage medium. When the computer program is executed by the processor 12, the steps of the above method embodiments may be implemented.

The computer program includes computer program code, which may be in source code form, object code form, executable file form, or some intermediate form, etc. The computer-readable medium may include any entity or device capable of carrying the computer program code, a recording medium, a U disk, a removable hard disk, a magnetic disk, an optical disk, a computer memory, a Read-Only Memory (ROM), a Random Access Memory (RAM), and other memories, etc.

Further, the computer-readable storage medium may mainly include a program storage area and a data storage area, wherein the program storage area may store an operating system, at least one application required for a function, and the like; the data storage area may store data created according to the use of the blockchain node, etc.

The bus may be a Peripheral Component Interconnect (PCI) bus or an Extended Industry Standard Architecture (EISA) bus, etc. The bus may be divided into an address bus, a data bus, a control bus, and the like. For ease of representation, only one arrow is used in FIG. 1, but it does not mean that there is only one bus or one type of bus. The bus is configured to implement connection and communication between the storage device 11 and at least one processor 12, etc.

The embodiments of the present application further provide a computer-readable storage medium (not shown in the figure). The computer-readable storage medium stores computer-readable instructions, and the computer-readable instructions are executed by the processor 12 in the head-mounted display device 1 to implement the correction method according to any of the above embodiments.

In the several embodiments provided in the present application, it should be understood that the disclosed systems, apparatuses, and methods may be implemented in other ways. For example, the apparatus embodiments described above are merely illustrative. For example, the division of modules is only a logical function division, and there may be other division methods in actual implementation.

The modules described as separate components may or may not be physically separated, and the components displayed as modules may or may not be physical units. That is, it can be located in one place, or distributed to multiple network units. Some or all of the modules can be selected according to actual needs to achieve the purpose of the solution of above embodiments.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

Furthermore, the word "comprising" does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure, rather than restrictions on the technical solutions. Although the present disclosure has been described in detail with reference to the above embodiments, those skilled in the art should understand that the technical solutions described in one embodiments can be modified, or some of technical features can be equivalently substituted, and these modifications or substitutions are not to detract from the essence of the corresponding technical solutions or from the scope of the technical solutions of the embodiments of the present disclosure .

What is claimed is:

1. A correction method applied to a head-mounted display device, wherein the head-mounted display device comprises at least one data acquisition unit, at least one display member, and an optical element;
the correction method comprising:
acquiring ocular information of a user by the at least one data acquisition unit;
determining whether the user is a first-time user of the head-mounted display device according to the ocular information of the user and user information;
in response to the user is determined the first-time user of the head-mounted display device, projecting a predetermined detection image from the at least one display member via the optical element to a left eye of the user and to a right eye of the user;
acquiring a first image of the left eye and a second image of the right eye by the at least one data acquisition unit according to same imaging parameters; and
correcting projection parameters of the at least one display member according to the first image and the second image.

2. The correction method of claim 1, wherein correcting the projection parameters of the at least one display member according to the first image and the second image comprises:
extracting a plurality of first features of the first image and a plurality of second features of the second image;
determining a plurality of deviation values between the plurality of first features and the plurality of second features; and
correcting the projection parameters of the at least one display member according to the plurality of deviation values and a plurality of first preset deviation ranges.

3. The correction method of claim 1, wherein correcting the projection parameters of the at least one display member according to the first image and the second image comprises:
extracting a plurality of first features of the first image and a plurality of second features of the second image;
determining a plurality of first difference values between the plurality of first features and a plurality of preset standard features, and determining a plurality of second difference values between the plurality of second features and the plurality of preset standard features; and
correcting the projection parameters of the at least one display member according to the plurality of first difference values, the plurality of second difference values, and a plurality of second preset deviation ranges.

4. The correction method of claim 1, wherein determining whether the user is a first-time user of the head-mounted display device according to the ocular information of the user and the user information comprises:
extracting first pupil features of the user according to the ocular information;
comparing each of the first pupil features with each of a plurality of second pupil features stored in the user information; and
in response to any one of the first pupil features is determined absent in the plurality of second pupil features, determining the user is the first-time user of the head-mounted display device.

5. The correction method of claim 1, further comprising:
obtaining the predetermined detection image by preprocessing a detection image.

6. The correction method of claim 1, wherein the at least one display member comprises a first display member, in response to the user is determined the first-time user of the head-mounted display device, projecting a predetermined detection image from the at least one display member via the optical element to the left eye of the user and to the right eye of the user comprises:
determining a left eye position and a right eye position of the user according to the ocular information of the user;
adjusting a projection position of the first display member according to the left eye position and the right eye position; and projecting the predetermined detection image simultaneously from the first display member via the optical element to the left eye of the user and to the right eye of the user.

7. The correction method of claim 1, wherein the at least one display member comprises a first display member and a second display member, in response to the user is determined the first-time user of the head-mounted display device, projecting a predetermined detection image from the at least one display member via the optical element to the left eye of the user and to the right eye of the user comprises:
determining a left eye position and a right eye position of the user according to the ocular information;
adjusting a first projection position of the first display member according to the left eye position and adjusting a second projection position of the second display member according to the right eye position; and
projecting the predetermined detection image from the first display member via the optical element to the left eye of the user, and projecting the predetermined detection image from to the second display member via the optical element to the right eye of the user.

8. The correction method of claim 1, wherein the at least one display member comprises a first display member and a second display member, in response to the user is determined the first-time user of the head-mounted display device, projecting a predetermined detection image from the at least one display member via the optical element to the left eye of the user and to the right eye of the user comprises:
determining a left eye position and a right eye position of the user according to the ocular information;
adjusting a third projection position of the first display member according to the left eye position and the right eye position, and adjusting a fourth projection position of the second display member according to the left eye position and the right eye position; and
projecting the predetermined detection image from the first display member via the optical element to the left eye of the user, and projecting the predetermined detection image from to the second display member via the optical element to the right eye of the user.

9. A head-mounted display device comprising:
at least one data acquisition unit;
at least one display member;
an optical element;
a processor; and
a storage device storing a plurality of instructions and, which when executed by the processor, cause the processor to:
acquire ocular information of a user by the at least one data acquisition unit;
determine whether the user is a first-time user of the head-mounted display device according to the ocular information of the user and user information;
in response to the user is determined the first-time user of the head-mounted display device, project a predetermined detection image from the at least one display member via the optical element to a left eye of the user and to a right eye of the user;
acquire a first image of the left eye and a second image of the right eye by the at least one data acquisition unit according to same imaging parameters;
correct projection parameters of the at least one display member according to the first image and the second image.

10. The head-mounted display device of claim 9, wherein the processor is further caused to:
extract a plurality of first features of the first image and a plurality of second features of the second image; and
determine a plurality of deviation values between the plurality of first features and the plurality of second features;
correct the projection parameters of the at least one display member according to the plurality of deviation values and a plurality of first preset deviation ranges.

11. The head-mounted display device of claim 9, wherein the processor is further caused to:
extract a plurality of first features of the first image and a plurality of second features of the second image;
determine a plurality of first difference values between the plurality of first features and a plurality of preset standard features, and determine a plurality of second difference values between the plurality of second features and the plurality of preset standard features; and
correct the projection parameters of the at least one display member according to the plurality of first difference values, the plurality of second difference values, and a plurality of second preset deviation ranges.

12. The head-mounted display device of claim 9, wherein the processor is further caused to:
extract first pupil features of the user according to the ocular information;
compare each of the first pupil features with each of a plurality of second pupil features stored in user information; and
in response to any one of the first pupil features is determined absent in the plurality of second pupil features, determine the user is the first-time user of the head-mounted display device.

13. The head-mounted display device of claim 9, wherein the at least one display member comprises a first display member; and the processor is further caused to:
determine a left eye position and a right eye position of the user according to the ocular information of the user;
adjust a projection position of the first display member according to the left eye position and the right eye position; and project the predetermined detection image simultaneously from the first display member via the optical element to the left eye of the user and separately to the right eye of the user.

14. The head-mounted display device of claim 9, wherein the at least one display member comprises a first display member and a second display member; and the processor is further caused to:
determine a left eye position and a right eye position of the user according to the ocular information of the user;
adjust a first projection position of the first display member according to the left eye position and adjust a second projection position of the second display member according to the right eye position; and
project the predetermined detection image from the first display member via the optical element to the left eye of the user, and project the predetermined detection image from to the second display member via the optical element to the right eye of the user.

15. A non-transitory storage medium stored thereon at least one computer-readable instructions that, when executed by a processor of a head-mounted display device, causes the processor to perform a correction method, the head-mounted display device comprising at least one data acquisition unit, at least one display member, and an optical element, the correction method comprising:
acquiring ocular information of a user by the at least one data acquisition unit;
determining whether the user is a first-time user of the head-mounted display device according to the ocular information of the user and user information;
in response to the user is determined the first-time user of the head-mounted display device, projecting a predetermined detection image from the at least one display member via the optical element to a left eye of the user and to a right eye of the user;
acquiring a first image of the left eye and a second image of the right eye by the at least one data acquisition unit according to same imaging parameters; and
correcting projection parameters of the at least one display member according to the first image and the second image.

16. The non-transitory storage medium of claim 15, wherein correcting the projection parameters of the at least one display member according to the first image and the second image comprises:
extracting a plurality of first features of the first image and a plurality of second features of the second image;
determining a plurality of deviation values between the plurality of first features and the plurality of second features; and
correcting the projection parameters of the at least one display member according to the plurality of deviation values and a plurality of first preset deviation ranges.

17. The non-transitory storage medium of claim 15, wherein the correcting projection parameters of the at least one display member according to the first image and the second image comprises:
extracting a plurality of first features of the first image and a plurality of second features of the second image;
determining a plurality of first difference values between the plurality of first features and a plurality of preset standard features, and determining a plurality of second difference values between the plurality of second features and the plurality of preset standard features; and
correcting the projection parameters of the at least one display member according to the plurality of first difference values, the plurality of second difference values, and a plurality of second preset deviation ranges.

18. The non-transitory storage medium of claim 15, wherein determining whether the user is a first-time user of the head-mounted display device according to the ocular information of the user and the user information comprises:
extracting first pupil features of the user according to the ocular information;
comparing each of the first pupil features with each of a plurality of second pupil features stored in the user information; and
in response to any one of the first pupil features is determined absent in the plurality of second pupil features, determining the user is the first-time user of the head-mounted display device.

19. The non-transitory storage medium of claim 15, wherein the at least one display member comprises a first display member, in response to the user is determined the first-time user of the head-mounted display device, projecting a predetermined detection image from the at least one display member via the optical element to the left eye of the user and to the right eye of the user comprises:
determining a left eye position and a right eye position of the user according to the ocular information of the user;
adjusting a projection position of the first display member according to the left eye position and the right eye position; and projecting the predetermined detection image simultaneously from the first display member via the optical element to the left eye of the user and to the right eye of the user.

20. The non-transitory storage medium of claim 15, wherein the at least one display member comprises a first display member and a second display member, in response to the user is determined the first-time user of the head-mounted display device, projecting a predetermined detection image from the at least one display member via the optical element to the left eye of the user and to the right eye of the user comprises:
determining a left eye position and a right eye position of the user according to the ocular information;
adjusting a first projection position of the first display member according to the left eye position and adjusting a second projection position of the second display member according to the right eye position; and
projecting the predetermined detection image from the first display member via the optical element to the left eye of the user, and projecting the predetermined detection image from to the second display member via the optical element to the right eye of the user.
